(19) United States
(12) Patent Application Publication
(10) Pub. No.: US 2025/0385260 A1
(43) Pub. Date: Dec. 18, 2025

(54) GRAPHENE PREPARATION METHOD USING LASER, AND SECONDARY BATTERY COMPRISING GRAPHENE COMPOSITE

(71) Applicant: KOREA INSTITUTE OF MACHINERY & MATERIALS, Daejeon (KR)

(72) Inventors: Hyung Cheoul SHIM, Daejeon (KR); Hak Jong CHOI, Daejeon (KR); Soongeun KWON, Gyeonggi-do (KR); Seung Min HYUN, Daejeon (KR); Hye Mi SO, Daejeon (KR); Jinyeong LEE, Daejeon (KR); Minsub OH, Seoul (KR); Areum KIM, Daejeon (KR)

(21) Appl. No.: 18/854,182

(22) PCT Filed: Mar. 20, 2023
(86) PCT No.: PCT/KR2023/003681

§ 371 Date: Feb. 26, 2025

(30) Foreign Application Priority Data
Apr. 4, 2022 (KR) 10-2022-0041890

(51) Int. Cl. H01M 4/587; C01B 32/184; H01G 11/32; H01G 11/86; H01M 4/72; H01M 10/052; H01M 10/058

(52) U.S. Cl. CPC H01M 4/587; C01B 32/184; H01G 11/32; H01G 11/86; H01M 4/72; H01M 10/052; H01M 10/058; C01P 2002/82; C01P 2004/03; C01P 2006/40

(57) ABSTRACT

A method for fabricating a graphene according to an embodiment of the present invention includes forming a precursor layer including a polymer on a metal pattern layer having a grid shape, and irradiating laser to the precursor layer to form a graphene layer. According to the method, quality and uniformity of laser-induced graphene may be increased without an additional complicated process.

### TECHNICAL FIELD

The present invention relates to a method for fabricating an electrode for a battery. More particularly, the present invention relates to a method for fabricating graphene using laser and a secondary battery including a graphene composite.

### BACKGROUND

Since graphene has a great conductivity and stability, usage of graphene for electrodes (as an active material, a capacitor electrode or the like) is being increased.

Recently, a method for fabricating graphene from a polymeric material containing carbon sources by photo-thermal effects or photo-chemical effects, which is induced by laser irradiation, is being researched. Quality of laser-induced graphene may change depending on composition of the polymeric material, power of laser, irradiation methods of laser or the like.

In order to improve quality of laser-induced graphene, power of laser may be increased, or laser may be duplicately irradiated with different focal lengths. However, when power of laser is excessively increased, a polymer substrate may be damaged. Furthermore, when laser may be duplicately irradiated, graphene formed from prior irradiation may be damaged by latter irradiation. When the latter irradiation is not performed within a duplicate location, quality of graphene may be decreased.

Thus, a manufacturing method needs to be developed to increase quality and uniformity of laser-induced graphene.

### PRIOR ARTS

### Non-Patent Literature

1. Nature Communications, 2014, 5, 5714.
2. ACS Nano 2018, 12, 2176-2183.

### DETAILED DESCRIPTION OF THE INVENTION

### Technical Problem to be Solved

The present invention provides a method for fabricating laser-induced graphene having improved quality and uniformity.

The present invention provides a secondary battery including graphene combined with a metal current-collecting layer without a binder.

### Means for Solving Problem

A method for fabricating a graphene according to an embodiment of the present invention includes forming a precursor layer including a polymer on a metal pattern layer having a grid shape, and irradiating laser to the precursor layer to form a graphene layer.

In an embodiment, the metal pattern layer includes a protrusion defining the grid shape. A height of the protrusion is 100 nm to 500 nm, and a period of the grid shape is 100 μm to 200 μm.

In an embodiment, the metal pattern layer includes a protrusion defining the grid shape, and a common layer disposed under the protrusion and being continuous entirely in the metal pattern layer.

In an embodiment, a thickness of the precursor layer is 10 μm to 30 μm.

In an embodiment, the precursor layer includes at least one selected from the group polyimide (PI), polyetherimide (PEI), polyetheretherketone (PEEK) and an epoxy resin.

In an embodiment, the precursor layer includes a polymer including both of a benzene ring and an imide group.

In an embodiment, the laser is CO₂ laser.

In an embodiment, the metal pattern layer includes a protrusion defining the grid shape, and the protrusion has an inversely-tapered shape.

In an embodiment, the metal pattern layer further includes a common layer disposed under the protrusion and being continuous entirely in the metal pattern layer, the common layer including a metal different from the protrusion.

A secondary battery according to an embodiment of the present invention includes a first electrode, a second electrode spaced apart from the first electrode, a separator disposed between the first electrode and the second electrode, and an electrolyte transferring ions between the first electrode and the second electrode. The first electrode includes a metal pattern layer and a graphene layer. The metal pattern layer has a grid shape. The graphene layer covers a convex-concave surface forming the grid shape.

### Effects of the Invention

According to the present invention, quality and uniformity of laser-induced graphene may be increased without an additional complicated process.

Furthermore, the graphene having high quality and uniformity may be combined with a metal substrate without an additional adhesive or binder. The metal substrate combined with the graphene may increase a specific capacity of a battery, and may increase efficiencies of processes for fabricating an electrode. Thus, performance and economic efficiency of a secondary battery may be improved.

### BRIEF DESCRIPTION OF THE DRAWINGS

FIGS. 1 to 3 are cross-sectional views illustrating a pattern substrate used for a method for fabricating graphene according to an embodiment of the present invention.

FIG. 4 is a plan view of the pattern substrate.

FIG. 5 and FIG. 6 are cross-sectional views illustrating a method for fabricating graphene using the pattern substrate and laser irradiation.

FIG. 7 is a cross-sectional view illustrating a graphene-metal composite obtained from an embodiment of the present invention.

FIG. 8 is a cross-sectional view illustrating a pattern substrate according to another embodiment of the present invention.

FIGS. 9 to 12 are cross-sectional views illustrating a method for fabricating graphene according to another embodiment of the present invention.

FIG. 13 is a cross-sectional view illustrating a secondary battery according to an embodiment of the present invention.

FIG. 14 shows graphs of Raman spectrums for Example 1 and Comparative Example 1 depending on position of a graphene layer (graphitized polyimide film).

FIG. 15A shows scanning electron microscopy (SEM) pictures (plan views) of metal pattern layers of Example 1 and Comparative Examples 2 to 4.

FIG. 15B shows graphs of Raman spectrums at a central position in a laser-irradiated area for Example 1 and Comparative Examples 2 to 4.

### BEST EMBODIMENT FOR IMPLEMENTING THE INVENTION

Example embodiments are described more fully hereinafter with reference to the accompanying drawings. The inventive concept may, however, be embodied in many different forms and should not be construed as limited to the example embodiments set forth herein. In the drawings, the sizes and relative sizes of layers and regions may be exaggerated for clarity. It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

### Method for Fabricating Graphene

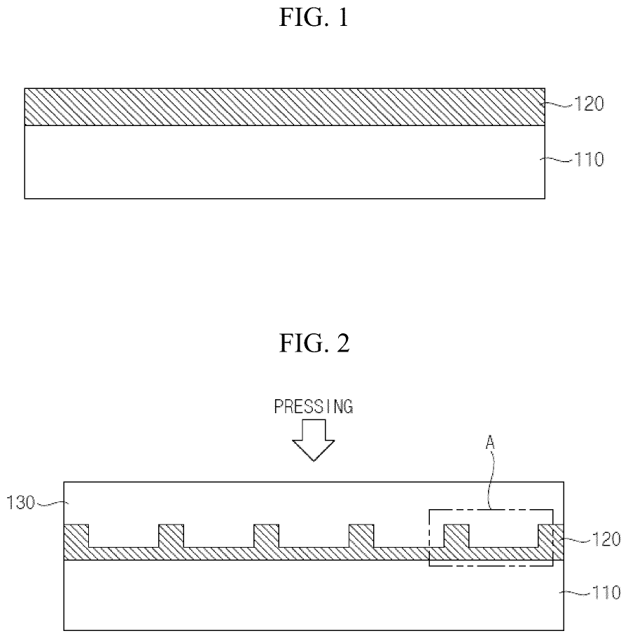

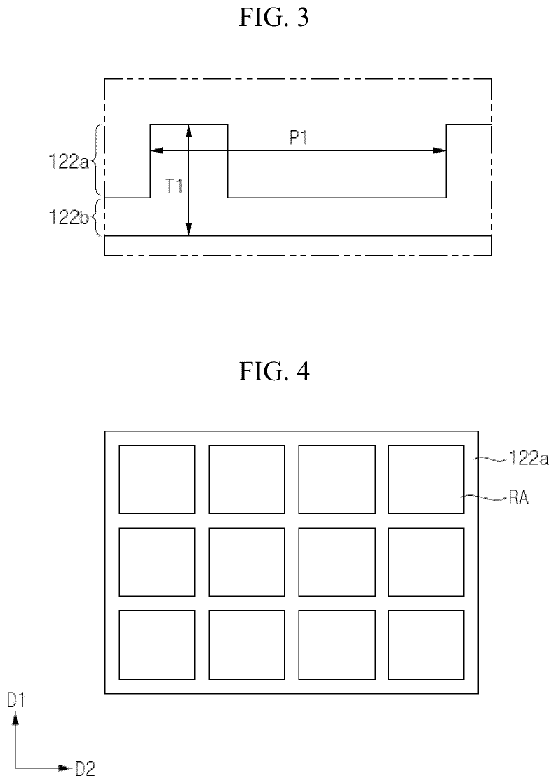

FIGS. 1 to 7 show a method for fabricating graphene according to an embodiment of the present invention. Particularly, FIGS. 1 to 3 are cross-sectional views illustrating a pattern substrate used for a method for fabricating graphene according to an embodiment of the present invention. FIG. 3 is an enlarged cross-sectional view of the region ‘A’ of FIG. 2.

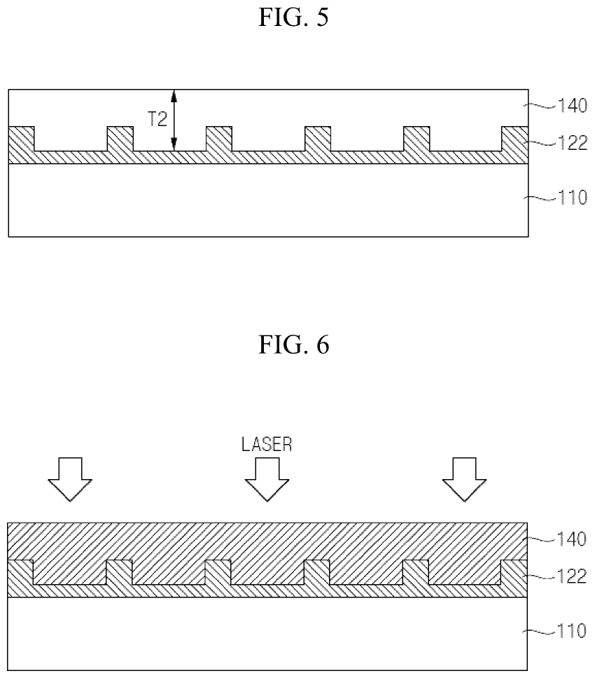

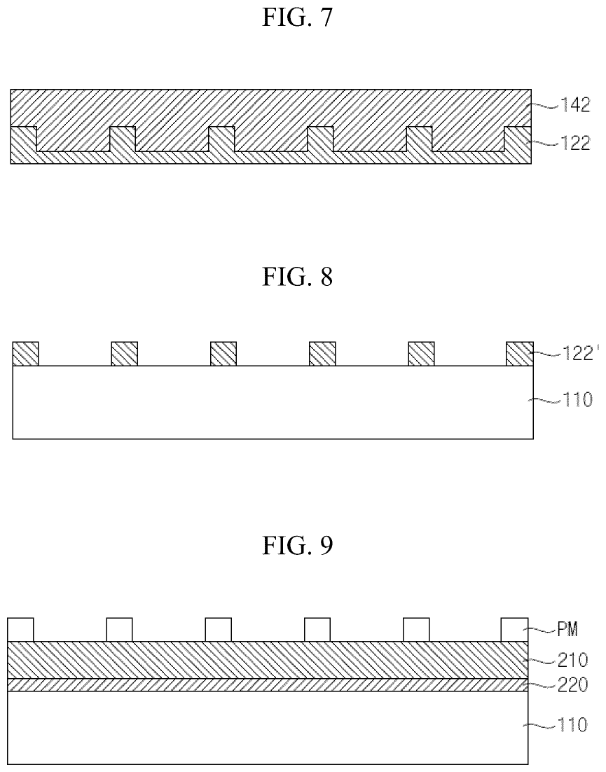

FIG. 4 is a plan view of the pattern substrate. FIG. 5 and FIG. 6 are cross-sectional views illustrating a method for fabricating graphene using the pattern substrate and laser irradiation. FIG. 7 is a cross-sectional view illustrating a graphene-metal composite obtained from an embodiment of the present invention.

Referring to FIG. 1, a metal layer 120 is formed on a base substrate 110. In an embodiment, the base substrate 110 may include quartz, glass, silicon, sapphire or the like. However, embodiments of the present invention are not limited thereto. For example, the base substrate 110 may include a metal or a polymer. When the base substrate 110 includes a metal, the base substrate 110 may include a metal different from the metal layer 120.

The metal layer 120 may be formed by various methods known in the art. For example, the metal layer 120 may be directly formed on the base substrate 110 by deposition such as sputtering, plating or the like. Alternatively, a metal foil may be laminated on the base substrate 110.

In an embodiment, a metal foil may be laminated on the base substrate 110 to form the metal layer 120. An adhesive may be used for lamination as desired.

For example, the metal layer 120 may include copper, aluminum, nickel, iron, titanium, molybdenum, manganese, cobalt, gold, silver, platinum, ruthenium, palladium or the like.

Referring to FIGS. 2 and 3, a metal pattern layer 122 is formed from the metal layer 120. In an embodiment, the metal pattern layer 122 may be formed through an imprinting method. In order to effectively performing the imprinting method, the metal layer 120 may include a metal having a relatively high ductility, for example, copper.

For example, after a mold 130 having a convex-concave pattern at a pressing surface may be disposed on the metal layer 120, the mold 130 may be pressed to form the metal pattern layer 122. The convex-concave pattern of the mold 130 may be an inversed shape of a convex-concave pattern to be formed at the metal pattern layer 120.

The metal pattern layer 122 may have a specific shape for plasmonic effects. For example, referring to FIGS. 3 and 4, the metal pattern layer 122 may have a grid shape. Particularly, the metal pattern layer 122 may include a protrusion 122a and a common layer 122b disposed under the protrusion 122a. The protrusion 122a may extend along a first direction D1 and a second direction D2, which cross each other, to surround a recessed area RA, which does not protrude. The common layer 122b may be entirely continuous in the metal pattern layer 122. An upper surface of the metal pattern layer 122, at which the protrusion 122a is disposed, may be referred to as a convex-concave surface.

In an embodiment, a period PI of the grid shape may be 50 μm to 200 μm. A height T1 of the protrusion 122a, which may be a depth of the recessed area, may be 100 nm to 500 nm. A duty ratio of the protrusion 122a, which may be a width to the period, may be 1% to 20%, and may be preferably 5% to 15%. For example, the width of the protrusion 122a may be 5 μm to 15 μm.

For example, photo-thermal effects of the metal pattern layer 122 may be optimized within the above range. A particular shape of the metal pattern layer 122 may change depending on a thickness of a precursor layer, which is formed in a following process, a wavelength of a laser or the like.

Referring to FIGS. 5 and 6, a precursor layer 140 is formed on the metal pattern layer 122. A laser is irradiated on the precursor layer 140 to form a graphene layer 142 from the precursor layer 140.

The precursor layer 140 may include a polymer. For example, the precursor layer 140 may include polyimide (PI), polyetherimide (PEI), polyetheretherketone (PEEK) or a combination thereof. Preferably, the polymer of the precursor layer 140 may include both of a benzene ring and an imide group. However, embodiments of the present invention are not limited thereto. For example, the precursor layer 140 may be formed from an epoxy resin, a commercially available photoresist material such as SU-8, or the like.

The precursor layer 140 may be formed by various methods. For example, a polymer film including a precursor may be laminated on the metal pattern layer 122, a solution including the precursor may be coated on the metal pattern layer 122, or after a solution including monomers of the precursor may be coated on the metal pattern layer 122, the precursor may be synthesized through reaction of the monomers.

In an embodiment, a thickness T2 of the precursor layer 140, which is a thickness in an area where the protrusion is not disposed, may be 10 μm to 30 μm. When, the thickness of the precursor layer 140 is excessively large, uniformity of graphene in the graphene layer 142 may be reduced, or graphitization may not be performed in a portion of the precursor layer 140.

The laser may be generated from various laser sources. For example, the laser may include a solid laser, a gas laser, an infrared ray laser, a CO₂ laser, a UV ray laser, a visible ray laser, a fiber laser or a combination thereof. In an embodiment, the laser may be CO₂ laser.

The laser may have various wavelengths and pulse widths, and may be irradiated with various powers. For example, a wavelength of the laser may be 1 nm to 100 μm. In an embodiment, a wavelength of the CO₂ laser may be 1 μm to 20 μm, a power thereof may be 1 W to 10 W, and a pulse width thereof may be 1 μs to 20 μs.

When the laser is irradiated, the precursor layer 140 may be graphitized to form the graphene layer 142. The graphene layer 142 may further include graphite, amorphous carbon, a precursor, which is not graphitized, or the like in addition to graphene.

For example, an SP3 carbon atom may be converted into an SP2 carbon atom so that graphene and/or graphite may be formed. Such conversion of carbon atoms may be induced by photo-thermal conversion, photo-chemical conversion or a combination thereof.

For example, the graphene may include single-layer graphene, multi-layer graphene, double-layer graphene, triple-layer graphene, doped graphene, porous graphene, pristine graphene, graphene oxide or a combination thereof. Furthermore, the graphene layer 142 may have a porous structure. For example, the graphene layer 142 may have a surface area of 100 m²/g to 3,000 m²/g.

According to the present invention, when the precursor layer 140 is graphitized by laser irradiation, photo-thermal reaction or photo-chemical reaction between laser and a polymer may be increased by the metal pattern layer 122 disposed on a lower surface of the precursor layer 140, which is opposite to a laser-incident surface. Thus, production of graphene may be increased. Furthermore, since photo-thermal reaction or photo-chemical reaction may be transferred in a lateral direction of the substrate by plasmonic effects, uniformity of graphene on the entire substrate may be increased, and graphene with high quality may be obtained without duplicate irradiation of laser.

Referring to FIG. 7, after the graphene layer 142 is formed, the graphene layer 142 and the metal pattern layer 122 may be separated from the base substrate 110. Since the graphene layer 142 is formed from the precursor layer 140 on the metal pattern layer 122, the graphene layer 142 may be combined with the metal pattern layer 122 without a binder.

Furthermore, since the graphene layer 142 includes graphene having a high purity, the graphene layer 142 and the metal pattern layer 122 may substantially form a graphene-metal composite. The graphene-metal composite may be used for various applications. For example, the graphene-metal composite may be used for an electrode of a battery, which will be explained more fully in the following.

FIG. 8 is a cross-sectional view illustrating a pattern substrate according to another embodiment. Referring to FIG. 8, a metal pattern layer 122′ may not include a common layer formed entirely on a base substrate 110, but may consist of a pattern disposed in a grid area.

FIGS. 9 to 12 are cross-sectional views illustrating a method for fabricating graphene according to another embodiment of the present invention.

Referring to FIG. 9, a lower metal layer 220 is disposed on a base substrate 110. An upper metal layer 210 is disposed on the lower metal layer 220.

The upper metal layer 210 and the lower metal layer 220 may include different materials so that the upper metal layer 210 and the lower metal layer 220 may have different etching selectivities. For example, the upper metal layer 210 may include copper, and the lower metal layer 220 may include aluminum. However, embodiments are not limited thereto, and various combinations may be selected from the above-exemplified metals such that the metals have different etching selectivities.

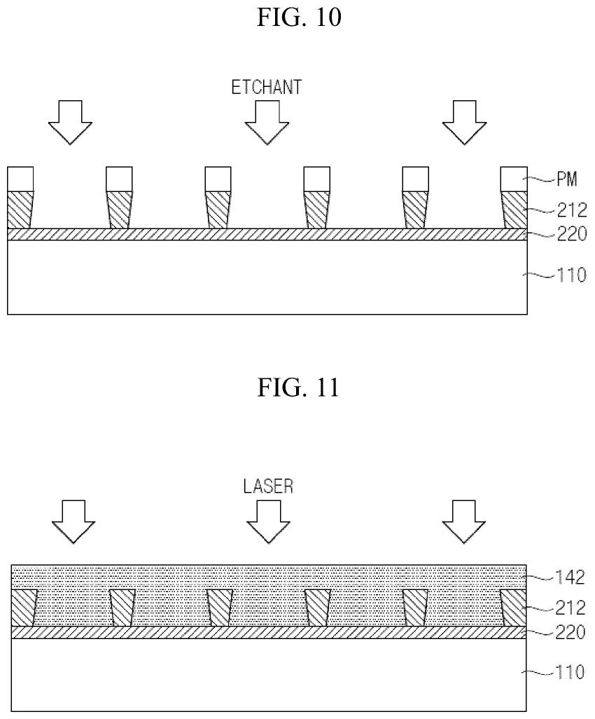

Referring to FIG. 10, a photo mask PM is formed on the upper metal layer 210. The photo mask PM partially covers the upper metal layer 210. The photo mask PM may have an opening that exposes an upper surface of the upper metal layer 210.

The photo mask PM may be formed from a photoresist material. For example, a photoresist composition may be coated on the upper metal layer 210 to form a photoresist film. A portion of the photoresist film, which corresponds to the photo mask PM or not, may be exposed to a light. The photoresist film may be developed to remove a portion of the photoresist film thereby forming the photo mask PM.

Thereafter, an etchant may be provided through the opening of the photo mask PM to etch an exposed portion of the upper metal layer 210 thereby forming a metal pattern layer 212. The etchant may have a composition to have an etching selectivity for the upper metal layer 210.

In a wet-etching process, etching may be isotropic. Since the lower metal layer 220 is not substantially etched by the etchant, a lower portion of the upper metal layer 210 may be etched more than an upper portion of the upper metal layer 210 is etched. Thus, in each pattern of the metal pattern layer 212, an upper surface and a side surface may form an acute angle, which is less than 90 degrees. Thus, each pattern of the metal pattern layer 212 may have an inversely-tapered shape thereby forming an acuter corner.

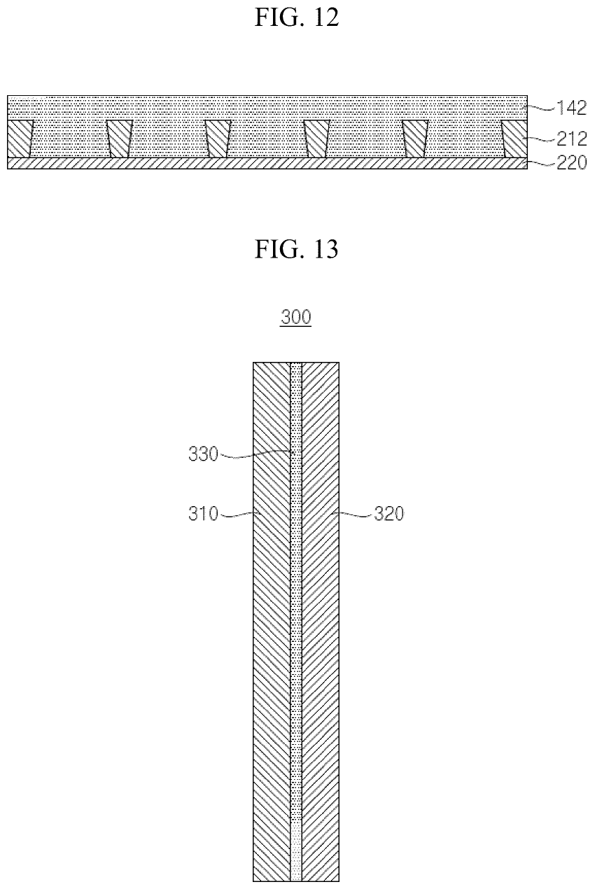

Referring to FIG. 11, after the photo mask PM is removed, a precursor layer is formed on the metal pattern layer 212. Thereafter, a laser is irradiated onto the precursor layer to form a graphene layer 142. A method for forming the graphene layer 142 may be substantially same as the previous explanation. Referring to FIG. 12, the graphene layer 142, the metal pattern layer 212 and the lower metal layer 220 may be separated from the base substrate 110 thereby forming a graphene-metal composite. The lower metal layer 220 may correspond to the previously explained common layer.

Each pattern of the metal pattern layer 212 has an acute corner. Thus, plasmonic effects of the metal pattern layer 212 may be increased. Thus, uniformity of the graphene layer 142 may be increased.

Furthermore, a portion having a greater width is farther from a lower surface so that the metal pattern layer 212 may have an anchor shape inserted into the graphene layer 142. Thus, a combining force between the metal pattern layer 212 and the graphene layer 142 may be increased. Thus, the metal pattern layer 212 and the graphene layer 142 may form a composite having improved reliability and mechanical properties.

### Secondary Battery

FIG. 13 is a cross-sectional view illustrating a secondary battery according to an embodiment of the present invention.

A secondary battery 300 according to an embodiment of the present invention may include a first electrode 310, a second electrode 320 and a separator 330 separating the first electrode 310 from the second electrode 320. For example, the first electrode 310 may be an anode, and the second electrode 320 may be a cathode. Furthermore, the secondary battery 300 may include an electrolyte to transfer ions between the first electrode 310 and the second electrode 320. The separator 330 may be impregnated with the electrolyte, or the electrolyte may be disposed between the separator 330 and the electrodes.

In an embodiment, at least one of the first electrode 310 and the second electrode 320 may include the previously explained graphene-metal composite. For example, the first electrode 310 may include the graphene-metal composite illustrated in FIG. 7 or illustrated in FIG. 12.

The graphene layer of the graphene-metal composite may functions as an anode active material or as a conductor. Since the graphene-metal composite includes a continuous metal layer, the graphene-metal composite may be used as an electrode without an additional current-collector. Furthermore, since the graphene-metal composite may be easily folded or bend, applicability may be enlarged.

When the second electrode 320 is a cathode, the second electrode 320 may include a cathode active material. For example, the cathode active material may include lithium transition metal oxide. For example, the cathode active material may include at least one selected from the group of Liₓ₁CoO₂ (0.5<x1<1.3), Liₓ₂NiO₂ (0.5<x2<1.3), Liₓ₃MnO₂ (0.5<x3<1.3), Liₓ₄Mn₂O₄ (0.5<x4<1.3), Liₓ₅(Niₐ₁CO_{b1}Mn_{c1})O₂(0.5<x5<1.3, 0<a1<1, 0<b1<1, 0<c1<1, a1+b1+c1=1), Liₓ₆Ni_{1-y1}CO_{y1}O₂ (0.5<x6<1.3, 0<y1<1), Liₓ₇Co_{1-y2}Mn_{y2}O₂ (0.5<x7<1.3, 0≤y2<1), Liₓ₈Ni_{1-y3}Mn_{y3}O₂ (0.5<x8<1.3, O≤y3<1), Liₓ₉ (Niₐ₂Co_{b2}Mn_{c2}) O₄ (0.5<x9<1.3, 0<a2<2, 0<b2<2, 0<c2<2, a2+b2+c2=2), Liₓ₁₀Mn_{2-z1}Ni_{z1}O₄ (0.5<x10<1.3, 0<z1<2), Liₓ₁₁Mn_{2-z2}CO_{z2}O₄ (0.5<x11<1.3, 0<z2<2), Liₓ₁₂CoPO₄ (0.5<x12<1.3) and Liₓ₁₃FePO₄ (0.5<x13<1.3).

For example, the separator 330 may include a conventional porous polymer film, which is formed of polyolefin-based polymer such as ethylene homopolymer, a propylene homopolymer, ethylene/butene copolymer, ethylene/hexene copolymer and ethylene/methacrylate copolymer, in a single film or a stack of films. In addition, a conventional non-woven fabric, for example, formed of glass fibers having a high melting point, polyethylene terephthalate fibers or the like may be used for the separator 330, however, embodiments are not limited thereto.

For example, the electrolyte may include an organic solvent including at least one selected from the group consisting of propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethyl methyl carbonate (EMC), gamma butyrolactone (GBL), fluoroethylene carbonate (FEC), methyl formate, ethyl formate, propyl formate, methyl acetate, ethyl acetate, propyl acetate, pentyl acetate, methyl propionate, ethyl propionate and butyl propionate.

The electrolyte may further include a lithium salt. An anion of the lithium salt may include at least one selected from the group consisting of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, F₃SO₃⁻, CF₃CF₂SO₃, (CF₃SO₂)₂N, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

A morphology of the secondary battery is not particularly limited. For example, the lithium secondary battery may have a cylindrical shape such as a can, a prismatic shape, a pouch shape, a coin shape or the like.

In the above, even though the graphene-metal composite is used for an anode, embodiments of the present invention are not limited thereto. For example, a cathode active material may be coated on the graphene-metal composite so that the graphene-metal composite may be used for a cathode.

Hereinafter, effects and applicability of embodiments of the present invention will be explained with reference to specific examples and experiments.

### EXAMPLE 1

A copper foil with a thickness of 5 μm was deposited on a silicon substrate. Thereafter, a metal pattern layer having a grid shape was formed from the copper foil through an imprinting method. A pattern period of the metal pattern layer was 100 μm, a width of a protrusion was 10 μm, and a height of the protrusion was 200 nm. A polyimide composition was coated on the metal pattern layer to form a polyimide film with a thickness of 20 μm. CO₂ laser (power: 2˜6W, wavelength: 10 μm, pulse width: 10˜15 μs) was irradiated onto the polyimide film with being moved in a direction to form a graphene layer.

### COMPARATIVE EXAMPLE 1

A polyimide film was formed with a thickness of 20 μm on a silicon substrate. According to a same method as Example 1, CO₂ laser was irradiated onto the polyimide film to form a graphene layer.

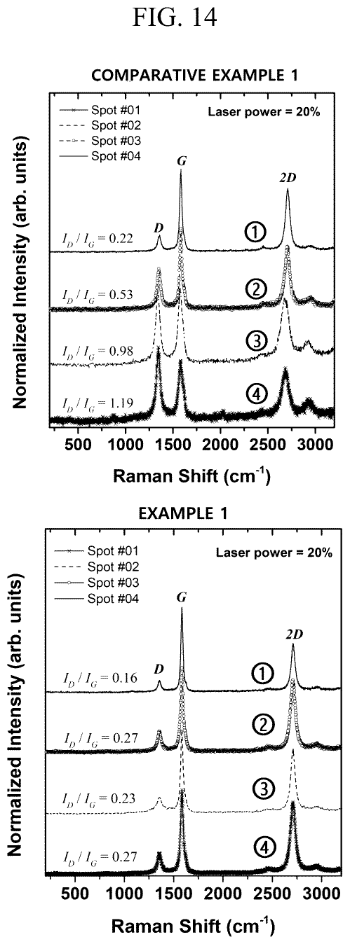

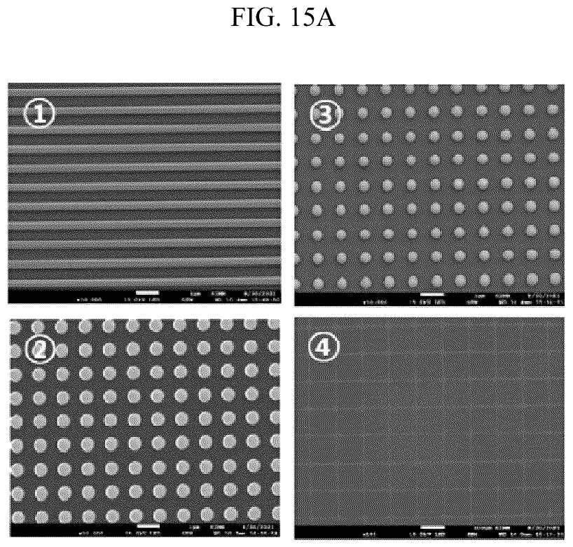

FIG. 14 shows graphs of Raman spectrums for Example 1 and Comparative Example 1 depending on position of a graphene layer (graphitized polyimide film). Particularly, \textcircled{1} is a central position in an area where the laser was irradiated. \textcircled{2}, \textcircled{3} and \textcircled{4} are far from \textcircled{1} in order in a direction crossing the moving direction of the laser. \textcircled{4} is far from \textcircled{1} by 50˜100 μm.

D-peak appearing near about 1350 cm⁻¹ of the Raman spectrum of FIG. 14 relates to defects of graphene. G-peak appearing near about 1580 cm⁻¹ relates to a graphite structure in graphene. When D-peak intensity to G-peak intensity is larger, graphene may have more defects, which mean a lower quality of graphene. For example, when photo-thermal effects or photo-chemical effects between a polymer and a laser are not sufficient, a crystal structure of graphite may not be fully formed, and amorphous carbon or the like may remain. Thus, I_{D}/I_{G} in Raman spectrum may be increased.

Referring to FIG. 14, in Comparative Example 1 without using the metal pattern layer, a quality of graphene was lower than Example 1 in a whole area. A quality difference was larger in the position farther from the central position. In contrast, in Example 1 μsing the metal pattern layer, a quality of graphene was relatively high in a whole area, and a quality difference was not large between the central position \textcircled{1} and the peripheral position \textcircled{4}. Thus, it can be noted that uniform graphene layer was obtained.

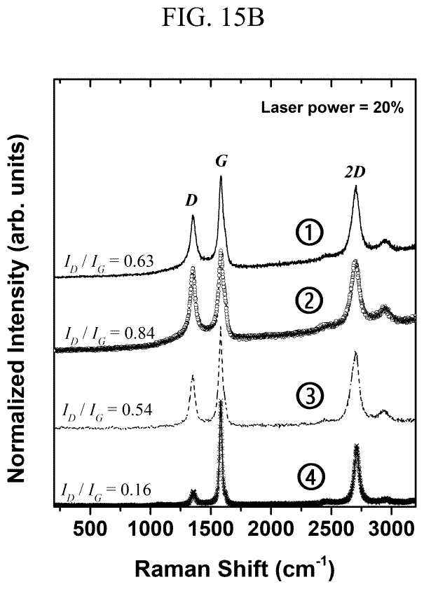

FIG. 15A shows scanning electron microscopy (SEM) pictures (plan views) of metal pattern layers of Example 1 and Comparative Examples 2 to 4. In FIG. 15a, bright regions represent protruding areas. FIG. 15B shows graphs of Raman spectrums at a central position in a laser-irradiated area for Example 1 and Comparative Examples 2 to 4.

Referring to FIGS. 15A and 15B, there is a remarkable difference between graphene qualities of Example 1 (\textcircled{4}) using a grid shape and Comparative Examples 2 to 4 (\textcircled{1}, \textcircled{2}, \textcircled{3}) using a linear shape, a circular shape and a dot shape. Thus, it can be noted that a shape of a metal patter layer affects diffusion of photo-thermal effects.

The foregoing is illustrative and is not to be construed as limiting thereof. Although a few embodiments have been described, those skilled in the art will readily appreciate that many modifications are possible in the embodiments without materially departing from the novel teachings, aspects, and advantages of the invention. Accordingly, all such modifications are intended to be included within the scope of this disclosure.

### Ability of Industrial Utility

The present invention may be used for fabrication of an electrode for a battery such as a lithium secondary battery, various electronic elements such as a super capacitor, a sensor or the like.

### REFERENCE NUMERALS

110: base substrate
122: metal pattern layer
140: precursor layer
142: graphene layer

1. A method for fabricating graphene, the method comprising:
forming a precursor layer including a polymer on a metal pattern layer having a grid shape; and
irradiating a laser to the precursor layer to form a graphene layer.

2. The method of claim 1, wherein the metal pattern layer includes a protrusion defining the grid shape, wherein a height of the protrusion is 100 nm to 500 nm, and a period of the grid shape is 100 μm to 200 μm.

3. The method of claim 1, wherein the metal pattern layer includes a protrusion defining the grid shape, and a common layer disposed under the protrusion and being continuous entirely in the metal pattern layer.

4. The method of claim 1, wherein a thickness of the precursor layer is 10 μm to 30 μm.

5. The method of claim 1, wherein the precursor layer includes at least one selected from the group polyimide (PI), polyetherimide (PEI), polyetheretherketone (PEEK) and an epoxy resin.

6. The method of claim 1, wherein the precursor layer includes a polymer including both of a benzene ring and an imide group.

7. The method of claim 1, wherein the laser is CO₂ laser.

8. The method of claim 1, wherein the metal pattern layer includes a protrusion defining the grid shape, and the protrusion has an inversely-tapered shape.

9. The method of claim 8, wherein the metal pattern layer further includes a common layer disposed under the protrusion and being continuous entirely in the metal pattern layer, the common layer including a metal different from the protrusion.

10. A secondary battery comprising:
a first electrode;
a second electrode spaced apart from the first electrode;
a separator disposed between the first electrode and the second electrode; and
an electrolyte transferring ions between the first electrode and the second electrode,
wherein the first electrode includes a metal pattern layer and a graphene layer, the metal pattern layer having a grid shape, the graphene layer covering a convex-concave surface forming the grid shape.

11. The secondary battery of claim 10, wherein the metal pattern layer includes a protrusion defining the grid shape, wherein a height of the protrusion is 100 nm to 500 nm, and a period of the grid shape is 100 μm to 200 μm.

12. The secondary battery of claim 10, wherein the metal pattern layer includes a protrusion defining the grid shape, and a common layer disposed under the protrusion and being continuous entirely in the metal pattern layer.

13. The secondary battery of claim 10, wherein the metal pattern layer includes a protrusion defining the grid shape, and the protrusion has an inversely-tapered shape.

14. The secondary battery of claim 13, wherein the metal pattern layer further includes a common layer disposed under the protrusion and being continuous entirely in the metal pattern layer, the common layer including a metal different from the protrusion.

15. The secondary battery of claim 10, wherein the graphene layer includes laser-induced graphene.
